(19) United States
(12) Patent Application Publication
(10) Pub. No.: US 2026/0368630 A1
(43) Pub. Date: Nov. 19, 2026

(54) SYSTEM AND METHOD FOR USER DATA EXPERIENCE AUTOMATED DATA ENRICHMENT PIPELINES

(71) Applicant: JPMorgan Chase Bank, N.A., New York, NY (US)

(72) Inventors: Stacy A NEWMAN, Easton, PA (US); Joseph KANNOOKADEN, Columbus, OH (US); Baishali K JAISWAL, Bangalore (IN); Hitesh BONDE, Dorset (GB); Santhosh ATCHUTUNI, Hyderabad (IN); Kishore B JASTI, Hyderabad (IN); Tom MARTIN, Lewis Center, OH (US); Gerald RICHLAND, Columbus, OH (US)

(73) Assignee: JPMorgan Chase Bank, N.A., New York, NY (US)

(21) Appl. No.: 19/251,373

(22) Filed: Jun. 26, 2025

(30) Foreign Application Priority Data
May 14, 2025 (IN) 202511046186

(51) Int. Cl. G06N 20/00; H04L 9/32

(52) U.S. Cl. CPC G06N 20/00; H04L 9/3236

(57) ABSTRACT

Various methods and processes, apparatuses/systems, and media for automated data enrichment are disclosed. A processor extracts raw data from a plurality of data sources via corresponding API call, the raw data having diverse data formats; implements a hashing algorithm on to the raw data received from said plurality of data sources to mask personally identifiable information from the raw data and completing extraction of the raw data with only mandatory fields; applies, after completing extraction of the raw data, a data preprocessing and transformation algorithm on to the raw data by iteratively transforming, aggregating, and de-duplicating data from the raw data to create refined features thereby transforming the raw data into a required standard readable format; validates the required standard readable format in real time by applying a validation schema algorithm; generates, upon validating, a first enriched dataset; and trains a machine learning model with the first enriched dataset.

### CROSS-REFERENCE TO RELATED APPLICATIONS

This application claims the benefit of priority from Indian Patent Application number 202511046186, filed May 14, 2025, which is herein incorporated by reference in its entirety.

### TECHNICAL FIELD

This disclosure generally relates to data processing, and, more particularly, to methods and apparatuses for implementing a platform, language, model, cloud, and database agnostic automated data enrichment module for automating data standardization and normalization process.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

With the growing information technology and people's ever-increasing demand, the need for timeliness and quality of data becomes stronger. At present, terminal devices obtain information by general-purpose processors. For instance, a general-purpose processor may run a specified application to implement object detection and classification, or to implement identification of the current environment, etc. However, in practical applications, this way of obtaining information by a general-purpose processor running a software program may be limited by the operating speed of the general-purpose processor thereby failing to automate data standardization and normalization processes, and in particular, when the general-purpose processor has a large load of data, the efficiency of data standardization and normalization processes may be comparatively low and the delay may be longer.

Moreover, in the field of data circulation, as the data volume is rapidly increased, the data quality of different data sources is irregular in reference, different concepts and standards exist in the data quality, and the data quality generally comprises quantitative descriptions of accuracy, completeness, timeliness, consistency and the like of the data. For users in big data age, the data amount required to be stored and processed may be large, the data source and the data structure may be various and complex, and many challenges may be brought to data standardization and normalization.

For example, when preparing data for training a model, there appears to be a significant time of work required to ensure the data has been normalized and enriched so that it may be properly used by a model. Many times, only a single data set is used, but when looking to understand more complexities, more data would be utilized, and the model would need to be trained on several data sets and file types. To join and normalize the data may prove to be problematic and manual, taking a long period of time, and may introduce human error into the mix. However, there appears to be no automation tool to automate data standardization and normalization. Also, if the process of data standardization and normalization has to be adapted to different inputs/outputs, it has to be manually modified to account for other inputs as the ones they were defined for, thereby adding complexity to the overall system or process, failing to resolve data integration or synchronization or transfer issues among various computer implemented tools having various heterogenous systems running therein and subjecting the overall systems to malicious cyber-attacks due to failing to normalize and standardize data accurately.

### SUMMARY

The present disclosure, through one or more of its various aspects, embodiments, and/or specific features or sub-components, provides, among other features, various systems, servers, devices, methods, media, programs, and platforms for implementing a platform, language, model, cloud, and database agnostic automated data enrichment module configured to automate data standardization and normalization process to train a machine learning model to improve performance of the machine learning model, but the disclosure is not limited thereto.

For example, the automated data enrichment module disclosed herein may be cloud-based AI/ML (Artificial Intelligence/Machine Learning) platform designed to automate data standardization and normalization. By transforming raw data into a standardized, readable format, automated data enrichment module disclosed herein may enhance data accuracy and accessibility, thereby streamlining data processes, reducing manual effort, and improving decision-making capabilities, and ensuring data integrity and reliability for users, but the disclosure is not limited thereto. As disclosed herein, the automated data enrichment module may be configured to leverage data engineering and infrastructure methods to standardize and automate the complex process of data standardization and normalization, setting it apart from traditional methods discussed above.

The automated data enrichment module disclosed herein may also be configured to handle diverse data formats and perform real-time validation and transformation, thereby substantially improving performance of the machine learning model and overall system performance. Moreover, by integrating seamlessly with existing systems, the automated data enrichment module may be configured to implement scalable and flexible approach to data management, thereby improving data processing efficiency, reducing manual data handling errors, and removing machine learning operations' dependency resulting in time and cost savings through automation as well as enhancing data quality and accessibility across the organization, but the disclosure is not limited thereto.

In some embodiments, the automated data enrichment module disclosed herein may also be configured to improve operational efficiency. For example, with granular error query analysis, the automated data enrichment module may facilitate early detection and alerting of system anomalies, minimizing downtime and improving system reliability. Automatic resolution may also be integrated with alerts, thereby reducing human intervention and improving machine learning model performance and overall system performance.

In some embodiments, a method for automated data enrichment to train a machine learning model by utilizing one or more processors along with allocated memory is disclosed. The method may include: establishing a communication link among a plurality of data sources and the machine learning model via a communication interface; extracting raw data from each of said plurality of data sources via corresponding application programming interface (API) call, the raw data having diverse data formats; implementing a hashing algorithm on to the raw data received from said plurality of data sources to mask personally identifiable information from the raw data and completing extraction of the raw data with only mandatory fields; applying, after completing extraction of the raw data, a data preprocessing and transformation algorithm on to the raw data by iteratively transforming, aggregating, and de-duplicating data from the raw data to create refined features thereby transforming the raw data into a required standard readable format; validating the required standard readable format in real time by applying a validation schema algorithm; generating, upon validating, a first enriched dataset; and training the machine learning model with the first enriched dataset to improve performance of the machine learning model.

In some embodiments, the method may further include: repeating the data preprocessing and transformation algorithm periodically to generate a second enriched dataset; determining that there is a data drift between the first enriched dataset and the second enriched dataset; and retraining the machine learning model with the second enriched dataset to improve performance of the machine learning model.

In some embodiments the method may further include: creating an alert and executing an automation process to take corrective action in case of model drift due to differences in the first enriched dataset and the second enriched dataset.

In some embodiments, in applying the data preprocessing and transformation algorithm, the method may further include: transforming values of numeric columns in a dataset of the raw data to a common scale, without distorting differences in ranges of values or losing information.

In some embodiments, the method may further include: determining that in the numeric columns there are some missing values; and filling the missing values in the numeric columns with “not applicable” or “null” as per data conversion requirement or replacing the missing values with estimated or calculated values using a regression algorithm.

In some embodiments, the method may further include: implementing a minimum-maximum normalization technique and a z-score normalization technique, wherein the minimum-maximum normalization technique scales the raw data between a specified range 0 and 1, and wherein the z-score normalization technique scales the raw data so that it has a mean of 0 and a standard deviation of 1.

In some embodiments according to the method, the de-duplicating data from the raw data may further include removing duplicate records considering the mandatory fields and timestamp fields.

In some embodiments, a system for automated data enrichment to train a machine learning model is disclosed. The system may include: a processor; and a memory operatively connected to the processor via a communication interface, the memory storing computer readable instructions, when executed, may cause the processor to: establish a communication link among a plurality of data sources and the machine learning model via a communication interface; extract raw data from each of said plurality of data sources via corresponding application programming interface (API) call, the raw data having diverse data formats; implement a hashing algorithm on to the raw data received from said plurality of data sources to mask personally identifiable information from the raw data and completing extraction of the raw data with only mandatory fields; apply, after completing extraction of the raw data, a data preprocessing and transformation algorithm on to the raw data by iteratively transforming, aggregating, and de-duplicating data from the raw data to create refined features thereby transforming the raw data into a required standard readable format; validate the required standard readable format in real time by applying a validation schema algorithm; generate, upon validating, a first enriched dataset; and train the machine learning model with the first enriched dataset to improve performance of the machine learning model.

In some embodiments according to the system, the processor may be further configured to: repeat the data preprocessing and transformation algorithm periodically to generate a second enriched dataset; determine that there is a data drift between the first enriched dataset and the second enriched dataset; and retrain the machine learning model with the second enriched dataset to improve performance of the machine learning model.

In some embodiments according to the system, the processor may be further configured to: create an alert and executing an automation process to take corrective action in case of model drift due to differences in the first enriched dataset and the second enriched dataset.

In some embodiments according to the system, in applying the data preprocessing and transformation algorithm, the processor may be further configured to: transform values of numeric columns in a dataset of the raw data to a common scale, without distorting differences in ranges of values or losing information.

In some embodiments, the processor may be further configured to: determine that in the numeric columns there are some missing values; and fill in the missing values in the numeric columns with “not applicable” or “null” as per data conversion requirement or replacing the missing values with estimated or calculated values using a regression algorithm.

In some embodiments, the processor may be further configured to: implement a minimum-maximum normalization technique and a z-score normalization technique, wherein the minimum-maximum normalization technique scales the raw data between a specified range 0 and 1, and wherein the z-score normalization technique scales the raw data so that it has a mean of 0 and a standard deviation of 1.

In some embodiments according to the system, the de-duplicating data from the raw data may further including removing duplicate records considering the mandatory fields and timestamp fields.

In some embodiments, a non-transitory computer readable medium configured to store instructions for automated data enrichment to train a machine learning model is disclosed. The instructions, when executed, may cause a processor to perform the following: establishing a communication link among a plurality of data sources and the machine learning model via a communication interface; extracting raw data from each of said plurality of data sources via corresponding application programming interface (API) call, the raw data having diverse data formats; implementing a hashing algorithm on to the raw data received from said plurality of data sources to mask personally identifiable information from the raw data and completing extraction of the raw data with only mandatory fields; applying, after completing extraction of the raw data, a data preprocessing and transformation algorithm on to the raw data by iteratively transforming, aggregating, and de-duplicating data from the raw data to create refined features thereby transforming the raw data into a required standard readable format; validating the required standard readable format in real time by applying a validation schema algorithm; generating, upon validating, a first enriched dataset; and training the machine learning model with the first enriched dataset to improve performance of the machine learning model.

In some embodiments according to the non-transitory computer readable medium, the instructions, when executed, may cause the processor to perform the following: repeating the data preprocessing and transformation algorithm periodically to generate a second enriched dataset; determining that there is a data drift between the first enriched dataset and the second enriched dataset; and retraining the machine learning model with the second enriched dataset to improve performance of the machine learning model.

In some embodiments according to the non-transitory computer readable medium, the instructions, when executed, may cause the processor to perform the following: creating an alert and executing an automation process to take corrective action in case of model drift due to differences in the first enriched dataset and the second enriched dataset.

In some embodiments according to the non-transitory computer readable medium, in applying the data preprocessing and transformation algorithm, the instructions, when executed, may cause the processor to perform the following: transforming values of numeric columns in a dataset of the raw data to a common scale, without distorting differences in ranges of values or losing information.

In some embodiments according to the non-transitory computer readable medium, the instructions, when executed, may cause the processor to perform the following: determining that in the numeric columns there are some missing values; and filling the missing values in the numeric columns with “not applicable” or “null” as per data conversion requirement or replacing the missing values with estimated or calculated values using a regression algorithm.

In some embodiments according to the non-transitory computer readable medium, the instructions, when executed, may cause the processor to perform the following: implementing a minimum-maximum normalization technique and a z-score normalization technique, wherein the minimum-maximum normalization technique scales the raw data between a specified range 0 and 1, and wherein the z-score normalization technique scales the raw data so that it has a mean of 0 and a standard deviation of 1.

In some embodiments according to the non-transitory computer readable medium, the de-duplicating data from the raw data may further include removing duplicate records considering the mandatory fields and timestamp fields.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic automated data enrichment module configured to automate data standardization and normalization process to train a machine learning model in accordance with an embodiment.

FIG. 2 illustrates a diagram of a network environment with a platform, language, database, and cloud agnostic automated data enrichment device in accordance with an embodiment.

FIG. 3 illustrates a system diagram for implementing a platform, language, database, and cloud agnostic automated data enrichment device having a platform, language, database, and cloud agnostic automated data enrichment module in accordance with an embodiment.

FIG. 4 illustrates a system diagram for implementing a platform, language, database, and cloud agnostic automated data enrichment module of FIG. 3 in accordance with an embodiment.

FIG. 5 illustrates a flow chart of a process implemented by the platform, language, database, and cloud agnostic automated data enrichment module of FIG. 4 for automating data standardization and normalization process to train a machine learning model in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art may appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, when preparing data for training a model, there appears to be a significant time of work required to ensure the data has been normalized and enriched so that it may be properly used by a model. Many times, only a single data set is used, but when looking to understand more complexities, more data would be utilized, and the model would need to be trained on several data sets and file types. To join and normalize the data may prove to be problematic and manual, taking a long period of time, and may introduce human error into the mix. However, there appears to be no automation tool to automate data standardization and normalization. Also, if the process of data standardization and normalization has to be adapted to different inputs/outputs, it has to be manually modified to account for other inputs as the ones they were defined for, thereby adding complexity to the overall system or process, failing to resolve data integration or synchronization or transfer issues among various computer implemented tools having various heterogenous systems running therein and subjecting the overall systems to malicious cyber-attacks due to failing to normalize and standardize data accurately.

The disclosed embodiments implement a platform, language, model, cloud, and database agnostic automated data enrichment module configured to automate data standardization and normalization process to train a machine learning model to improve performance of the machine learning model, but the disclosure is not limited thereto.

For example, the automated data enrichment module disclosed herein may be cloud-based AI/ML (Artificial Intelligence/Machine Learning) platform designed to automate data standardization and normalization. By transforming raw data into a standardized, readable format, automated data enrichment module disclosed herein may enhance data accuracy and accessibility, thereby streamlining data processes, reducing manual effort, and improving decision-making capabilities of the machine learning model, and ensuring data integrity and reliability for users, but the disclosure is not limited thereto. As disclosed herein, the automated data enrichment module may be configured to leverage data engineering and infrastructure methods to standardize and automate the complex process of data standardization and normalization, setting it apart from traditional methods discussed above.

The automated data enrichment module disclosed herein may also be configured to handle diverse data formats and perform real-time validation and transformation, thereby substantially improving performance of the machine learning model and overall system performance. Moreover, by integrating seamlessly with existing systems, the automated data enrichment module may be configured to implement scalable and flexible approach to data management, thereby improving data processing efficiency, reducing manual data handling errors, and removing machine learning operations' dependency resulting in time and cost savings through automation as well as enhancing data quality and accessibility across the organization, but the disclosure is not limited thereto.

While many of the exemplary embodiments discussed herein focus on applications in distributed database domain, it should be understood that the technology described herein may be applied to a wide variety of other application domains.

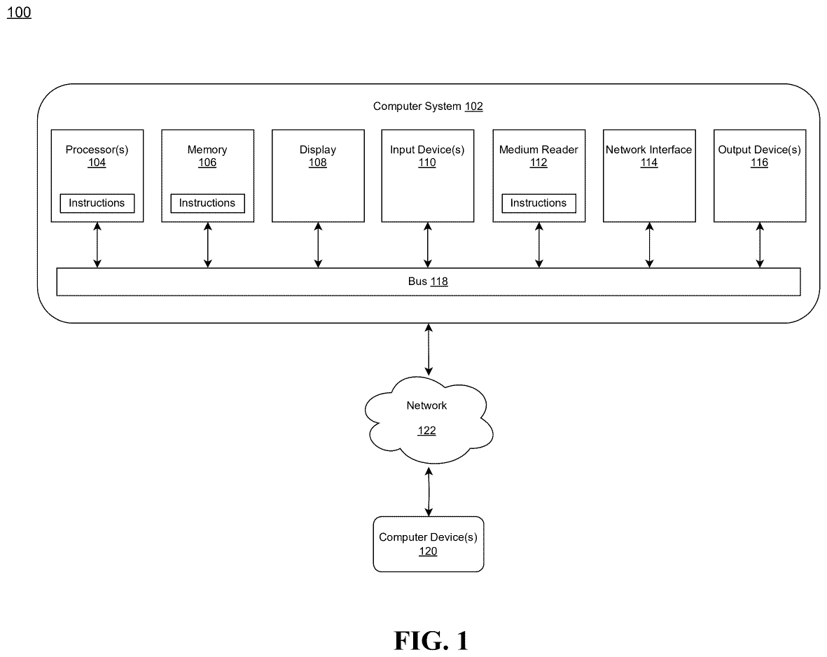

FIG. 1 is an exemplary system 100 for use in implementing a platform, language, database, and cloud agnostic automated data enrichment module configured to automate data standardization and normalization process to train a machine learning model to improve performance of the machine learning model, but the disclosure is not limited thereto. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the automated data enrichment module may be platform, language, model, database, and cloud agnostic that may allow for consistent easy orchestration and passing of data through various components of the automated data enrichment module to output a desired result, i.e., alerts to remedy model's performance issues and system's latency issues, regardless of platform, browser, language, model, database, and cloud environment. Since the disclosed process, in some embodiments, may be platform, language, database, browser, and cloud agnostic, the automated data enrichment module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

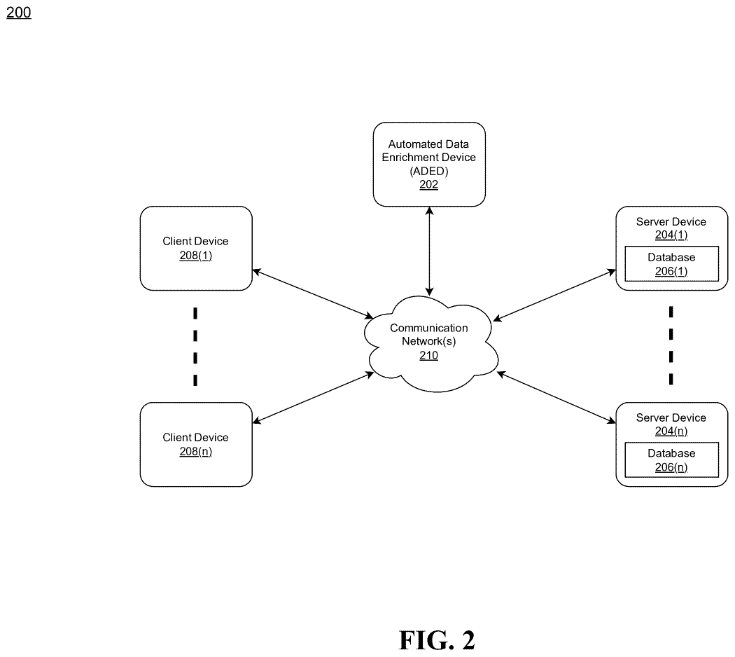

Referring to FIG. 2, a schematic of an exemplary network environment 200 for implementing a language, platform, database, model and cloud agnostic automated data enrichment device (ADED) of the instant disclosure is illustrated.

In some embodiments, the above-described problems associated with conventional tools may be overcome by implementing an ADED 202 as illustrated in FIG. 2 that may be configured for implementing a platform, language, database, and cloud agnostic automated data enrichment module configured to automate data standardization and normalization process to train a machine learning model to improve performance of the machine learning model, but the disclosure is not limited thereto. For example, the cloud-based automated data enrichment module within the ADED 202 disclosed herein may be configured to leverage data engineering and infrastructure methods to standardize and automate the complex process of data standardization and normalization, setting it apart from traditional methods discussed above.

In some embodiments, the automated data enrichment module within the ADED 202 disclosed herein may be configured to handle diverse data formats and perform real-time validation and transformation, thereby substantially improving performance of the machine learning model and overall system performance. Moreover, by integrating seamlessly with existing systems, the automated data enrichment module within the ADED 202 disclosed herein may be configured to implement scalable and flexible approach to data management, thereby improving data processing efficiency, reducing manual data handling errors, and removing machine learning operations' dependency resulting in time and cost savings through automation as well as enhancing data quality and accessibility across the organization, but the disclosure is not limited thereto.

The ADED 202 may have one or more computer system 102s, as described with respect to FIG. 1, which in aggregate provide the necessary functions.

The ADED 202 may store one or more applications that may include executable instructions that, when executed by the ADED 202, cause the ADED 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADED 202 itself, may be located in virtual server(s) running in a cloud-based computing environment rather than being tied to one or more specific physical network computing devices. Also, the application(s) may be running in one or more virtual machines (VMs) executing on the ADED 202. Additionally, in one or more embodiments of this technology, virtual machine(s) running on the ADED 202 may be managed or supervised by a hypervisor.

In the network environment 200 of FIG. 2, the ADED 202 may be coupled to a plurality of server devices 204(1)-204(n) that hosts a plurality of databases 206(1)-206(n), and also to a plurality of client devices 208(1)-208(n) via communication network(s) 210. A communication interface of the ADED 202, such as the network interface 114 of the computer system 102 of FIG. 1, operatively couples and communicates between the ADED 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADED 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus may not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The ADED 202 may be a standalone device or integrated with one or more other devices or apparatuses, such as one or more of the server devices 204(1)-204(n). In some embodiments, the ADED 202 may be hosted by one of the server devices 204(1)-204(n), and other arrangements may also be possible. Moreover, one or more of the devices of the ADED 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the ADED 202 via the communication network(s) 210 according to the HTTP-based and/or JSON protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the ADED 202 that may efficiently provide a platform for implementing a platform, language, model, database, and cloud agnostic automated data enrichment module configured to automate data standardization and normalization process to train a machine learning model to improve performance of the machine learning model and to provide the other technological improvements mentioned earlier, but the disclosure is not limited thereto.

The client devices 208(1)-208(n) may run interface applications, such as standard web browsers or standalone client applications, which may provide an interface to communicate with the ADED 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the ADED 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ADED 202, the server devices 204(1)-204(n), or the client devices 208(1)-208(n), in some embodiments, may be configured to operate as virtual instances on the same physical machine. In some embodiments, one or more of the ADED 202, the server devices 204(1)-204(n), or the client devices 208(1)-208(n) may operate on the same physical device rather than as separate devices communicating through communication network(s) 210. Additionally, there may be more or fewer ADEDs 202, server devices 204(1)-204(n), or client devices 208(1)-208(n) than illustrated in FIG. 2. In some embodiments, the ADED 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

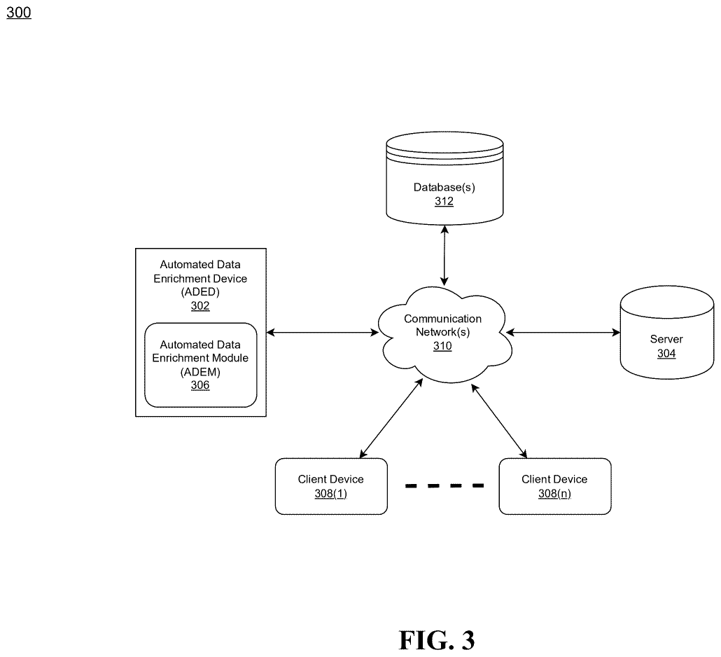

FIG. 3 illustrates a system diagram for implementing a platform, language, and cloud agnostic ADED having a platform, language, database, and cloud agnostic automated data enrichment module (ADEM) in accordance with an embodiment.

As illustrated in FIG. 3, the system 300 may include an ADED 302 within which an ADEM 306 may be embedded, a server 304, a database(s) 312, a plurality of client devices 308(1) . . . 308(n), and a communication network 310.

In some embodiments, the ADED 302 including the ADEM 306 may be connected to the server 304, and the database(s) 312 via the communication network 310. The ADED 302 may also be connected to the plurality of client devices 308(1) . . . 308(n) via the communication network 310, but the disclosure is not limited thereto.

According to exemplary embodiment, the ADED 302 is described and shown in FIG. 3 as including the ADEM 306, although it may include other rules, policies, modules, databases, or applications, etc. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the ADEM 306 may be configured to receive real-time feed of data from the plurality of client devices 308(1) . . . 308(n) and secondary sources via the communication network 310.

As may be described below, the ADEM 306 may be configured to: establish a communication link among a plurality of data sources and the machine learning model via a communication interface; extract raw data from each of said plurality of data sources via corresponding API call, the raw data having diverse data formats; implement a hashing algorithm on to the raw data received from said plurality of data sources to mask personally identifiable information from the raw data and completing extraction of the raw data with only mandatory fields; apply, after completing extraction of the raw data, a data preprocessing and transformation algorithm on to the raw data by iteratively transforming, aggregate, and de-duplicating data from the raw data to create refined features thereby transforming the raw data into a required standard readable format; validate the required standard readable format in real time by applying a validation schema algorithm; generate, upon validating, a first enriched dataset; and train the machine learning model with the first enriched dataset to improve performance of the machine learning model; repeat the data preprocessing and transformation algorithm periodically to generate a second enriched dataset; determine that there is a data drift between the first enriched dataset and the second enriched dataset; and retrain the machine learning model with the second enriched dataset to further improve performance of the machine learning model, but the disclosure is not limited thereto.

The plurality of client devices 308(1) . . . 308(n) are illustrated as being in communication with the ADED 302. In this regard, the plurality of client devices 308(1) . . . 308(n) may be “clients” (e.g., customers) of the ADED 302 and are described herein as such. Nevertheless, it is to be known and understood that the plurality of client devices 308(1) . . . 308(n) need not necessarily be “clients” of the ADED 302, or any entity described in association therewith herein. Any additional or alternative relationship may exist between either or both of the plurality of client devices 308(1) . . . 308(n) and the ADED 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the ADED 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ADED 302 may be the same or similar to the ADED 202 as described with respect to FIG. 2, including any features or combination of features described with respect thereto.

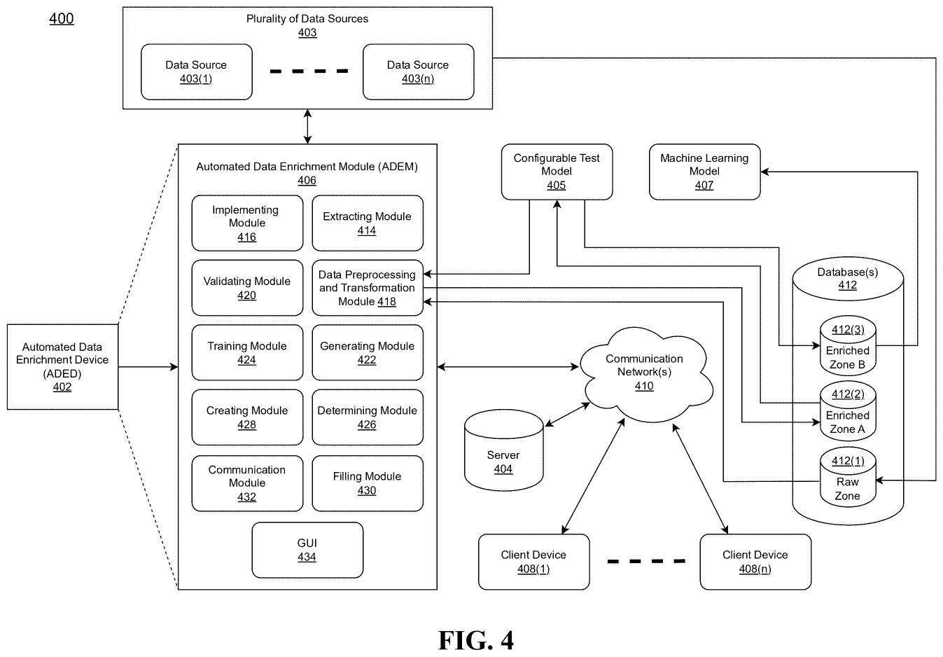

FIG. 4 illustrates a system diagram for implementing a platform, language, database, and cloud agnostic ADEM of FIG. 3 in accordance with an exemplary embodiment.

In some embodiments, the system 400 may include a platform, language, model, database, and cloud agnostic ADED 402 within which a platform, language, model, database, and cloud agnostic ADEM 406 may be embedded, a server 404, a plurality of data sources 403 including data sources 403(1)-403(n), a configurable test model 405, a machine learning model 407, a communication network 410, and database(s) 412 including a raw zone 412(1), an enriched zone A 412(2), and an enriched zone B 412(3). In some embodiments, the application server 404 may comprise a plurality of servers located centrally or located in different locations, but the disclosure is not limited thereto.

In some embodiments, the ADED 402 including the ADEM 406 may be connected to the server 404, the plurality of data sources 403 including data sources 403(1)-403(n), the configurable test model 405, the machine learning model 407, and database(s) 412 via the communication network 410. The ADED 402 may also be connected to the plurality of client devices 408(1)-408(n) via the communication network 410, but the disclosure is not limited thereto. The ADEM 406, the server 404, the plurality of client devices 408(1)-408(n), the database(s) 412, the communication network 410 as illustrated in FIG. 4 may be the same or similar configuration to the ADEM 306, the server 304, the plurality of client devices 308(1)-308(n), the database(s) 312, the communication network 310, respectively, as illustrated in FIG. 3.

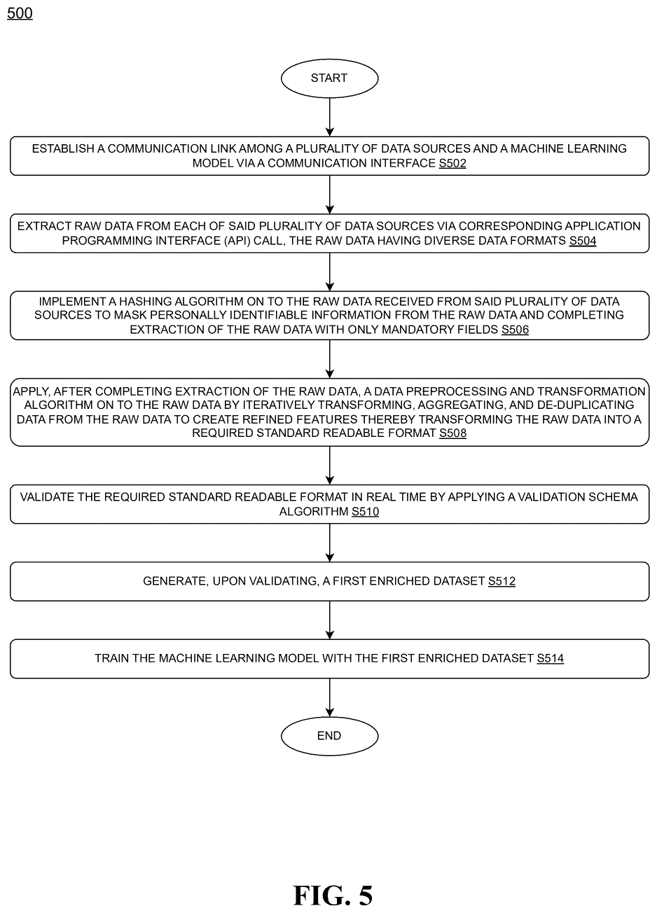

In some embodiments, as illustrated in FIG. 4, the ADEM 406 may include an extracting module 414, an implementing module 416, a data preprocessing and transformation module 418, a validating module 420, a generating module 422, a training module 424, a determining module 426, a creating module 428, a filling module 430, a communication module 432, and a Graphical User Interface (GUI) 434. In some embodiments, interactions and data exchange among these modules included in the ADEM 406 provide the advantageous effects of the disclosed invention. Functionalities of each module of FIG. 4 may be described in detail below with reference to FIGS. 4-5.

In some embodiments, each of the extracting module 414, implementing module 416, data preprocessing and transformation module 418, validating module 420, generating module 422, training module 424, determining module 426, creating module 428, filling module 430, and the communication module 432 of the ADEM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the extracting module 414, implementing module 416, data preprocessing and transformation module 418, validating module 420, generating module 422, training module 424, determining module 426, creating module 428, filling module 430, and the communication module 432 of the ADEM 406 of FIG. 4 may be implemented by microprocessors or similar, and may be programmed using software (e.g., microcode) to perform various functions discussed herein and may optionally be driven by firmware and/or software.

Alternatively, in some embodiments, each of the extracting module 414, implementing module 416, data preprocessing and transformation module 418, validating module 420, generating module 422, training module 424, determining module 426, creating module 428, filling module 430, and the communication module 432 of the ADEM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the ADEM 406 of FIG. 4 may also be implemented by cloud-based deployment.

In some embodiments, each of the extracting module 414, implementing module 416, data preprocessing and transformation module 418, validating module 420, generating module 422, training module 424, determining module 426, creating module 428, filling module 430, and the communication module 432 of the ADEM 406 of FIG. 4 may be called via corresponding API, but the disclosure is not limited thereto. For example, in some embodiments, the extracting module 414 may be called via a first API, the implementing module 416 may be called via a second API, the data preprocessing and transformation module 418 may be called via a third API, the validating module 420 may be called via a fourth API, the generating module 422 may be called via a fifth API, the training module 424 may be called via a sixth API, the determining module 426 may be called via a seventh API, the creating module 428 may be called via an eight API, the filling module 430 may be called via a ninth API, and the communication module 432 may be called via a tenth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the ADEM 406 may be executed via the communication module 432, and the communication network 410, which may comprise plural networks as described above. In some embodiments, in an exemplary embodiment, the various components of the ADEM 406 may communicate with the application server 404, the plurality of data sources 403, the configurable test model 405, the machine learning model 407, and the database(s) 412 via the communication module 432 and the communication network 410 and the output results of the machine learning model 407 may be displayed onto the GUI 434. Of course, these embodiments are merely exemplary and are not limiting or exhaustive. The database(s) 412 may include the databases included within the private cloud and/or public cloud and the server 404 may include one or more servers within the private cloud and the public cloud.

FIG. 5 illustrates a flow chart of a process 500 implemented by the ADEM 406 of FIG. 4 for automating data standardization and normalization process to train a machine learning model in accordance with an embodiment. It may be appreciated that the illustrated process 500 and associated steps may be performed in a different order, with illustrated steps omitted, with additional steps added, or with a combination of reordered, combined, omitted, or additional steps.

In some embodiments, the interactions among the components of the ADEM 406 of FIG. 4 utilizing the steps of FIG. 5, cause the ADEM 406 to automate data standardization and normalization process to train the configurable test model 405 and the machine learning model 407 to improve performance of the configurable test model 405 and the machine learning model 407, but the disclosure is not limited thereto.

For example, the ADEM 406 disclosed herein may be configured to be implemented as a cloud-based AI/ML platform designed to automate data standardization and normalization. By transforming raw data into a standardized, readable format, the ADEM 406 disclosed herein may enhance data accuracy and accessibility, thereby streamlining data processes, reducing manual effort, and improving decision-making capabilities, and ensuring data integrity and reliability for users, but the disclosure is not limited thereto. As disclosed herein, the ADEM 406 may be configured to leverage data engineering and infrastructure methods to standardize and automate the complex process of data standardization and normalization, setting it apart from traditional methods discussed above.

In some embodiments, the ADEM 406 disclosed herein may also be configured to handle diverse data formats and perform real-time validation and transformation, thereby substantially improving performance of the machine learning model 407 and overall system performance. Moreover, by integrating seamlessly with existing systems, the ADEM 406 may be configured to implement scalable and flexible approach to training the machine learning model 407, thereby improving data processing efficiency, reducing manual data handling errors, and removing machine learning operations' dependency resulting in time and cost savings through automation as well as enhancing data quality and accessibility across the organization, but the disclosure is not limited thereto.

In some embodiments, the ADEM 406 disclosed herein may also be configured to improve operational efficiency. For example, with granular error query analysis, the automated data enrichment module may facilitate early detection and alerting of system anomalies, minimizing downtime and improving system reliability. Automatic resolution may also be integrated with alerts, thereby reducing human intervention and improving the performance of the machine learning model 407 and overall system performance.

The interactions among the components of the ADEM 406 of FIG. 4 utilizing the steps of FIG. 5 are disclosed below.

Referring to FIGS. 4-5, in some embodiments, at step S502, the process 500 may include establishing a communication link, by calling the communication module 432 (see FIG. 4) via the tenth API, among the plurality of data sources 403 including the data source 403(1)-403(n), the configurable test model 405, and the machine learning model 407 via the communication network 410 by utilizing the client device 408(1)-408(n) via a communication interface within the GUI 434.

In some embodiments, at step S504, the process 500 implemented by the ADEM 406 may include extracting, by calling the extracting module 414 via the first API, raw data from each of the plurality of data sources 403(1)-403(n) via corresponding API call, the raw data having diverse data formats. The raw data may be stored onto the raw zone 412(1), but the disclosure is not limited thereto.

In some embodiments, at step S506, the process 500 implemented by the ADEM 406 may include, implementing by calling the implementing module 416 via the second API, a hashing algorithm on to the raw data received from the plurality of data sources 403(1)-403(n) to mask personally identifiable information (PII) from the raw data and completing extraction of the raw data with only mandatory fields and storing the mandatory fields information along with the raw data onto the raw zone 412(1).

In some embodiments, the PII may refer to personal data, such as email addresses, phone numbers, credit card numbers, social security numbers, and other types of data that can be used to identify a specific user. Hashing is the process of transforming any given key or a string of characters into another value. This is usually represented by a shorter, fixed-length value or key that represents and makes it easier to find or employ the original string.

At step S506, the hashing algorithm implemented by the ADEM 406 may include setting up hash tables. A hash table may store key and value pairs in a list that may be accessible through its index. Because the number of keys and value pairs may be unlimited, the hash function maps the keys to the table size. A hash value then becomes the index for a specific element.

At step S508, after completing extraction of the raw data, the process 500 implemented by the ADEM 406 may include applying, by calling the data preprocessing and transformation module 418 via the third API, a data preprocessing and transformation algorithm on to the raw data by iteratively transforming, aggregating, and de-duplicating data from the raw data to create refined features thereby transforming the raw data into a required standard readable format.

At step S508, in applying the data preprocessing and transformation algorithm, the process 500 implemented by the ADEM 406 may further include transforming values of numeric columns in a dataset of the raw data to a common scale, without distorting differences in ranges of values or losing information; determining, by calling the determining module 426 via the seventh API that in the numeric columns there are some missing values; and filling, by calling the filling module 430 via the ninth API, the missing values in the numeric columns with “not applicable” or “null” as per data conversion requirement or replacing the missing values with estimated or calculated values using a regression algorithm.

The missing value analysis procedure implemented by the ADEM 406 may describe the pattern of missing data. Where are the missing values located? How extensive are they? Do pairs of variables tend to have values missing in multiple cases? Are data values extreme? Are values missing randomly? etc. The missing value analysis procedure implemented by the ADEM 406 may estimate means, standard deviations, covariances, and correlations for different missing value methods including, but not limited thereto, listwise, pairwise, regression, or EM (expectation-maximization). The pairwise method may also display counts of pairwise complete cases.

In some embodiments, the fills in (imputes) missing values with estimated values as implemented by the ADEM 406 may also include using regression or EM methods; however, multiple imputation may be generally considered to provide more accurate results. Missing value analysis as implemented by the ADEM 406 may help addressing several concerns caused by incomplete data.

Data aggregation as implemented by the ADEM 406 may include an automated process of combining, compiling and organizing large volumes of data from the data sources 403(1)-403(n) into one unified body. In some embodiments, data aggregation may be performed in several ways, depending on the type of data and the goals of an organization. For example, a time aggregation process may be implemented by the ADEM 406 is the process of grouping together data points based on time intervals, such as hourly, daily, weekly, monthly or yearly. Time aggregation may be useful for tracking trends over a period of time and identifying seasonal fluctuations in customer behavior. A spatial aggregation process may also be implemented by the ADEM 406 that may involve the grouping of data points received from the data source(s) 403(1)-403(n) over a specified time period.

At step S508, in applying the data preprocessing and transformation algorithm, the process 500 implemented by the ADEM 406 may further include implementing, by calling the implementing module 416 via the second API, a minimum-maximum normalization technique and a z-score normalization technique, wherein the minimum-maximum normalization technique scales the raw data between a specified range 0 and 1, and wherein the z-score normalization technique scales the raw data so that it has a mean of 0 and a standard deviation of 1.

In machine learning, the foundation for successful models may be built on the quality of data they are trained on. Machine learning algorithms may be often trained with the assumption that all features contribute equally to the final prediction. However, this assumption fails when the features differ in range and unit, hence affecting their importance.

Normalization may prove to be a specific form of feature scaling that transforms the range of features to a standard scale by the data preprocessing and transformation module 418 interacting with the configurable test model 405. For example, normalized data may enhance model performance and may improve the accuracy of a model, i.e., the configurable test model 405, the machine learning model 407. It may aid algorithms that rely on distance metrics, such as k-nearest neighbors or support vector machines, by preventing features with larger scales from dominating the learning process. In some embodiments, the configurable test model 405 and the machine learning model 407 may be the same machine learning model wherein the machine learning model 407 may be an enhanced version of the configurable test model 405.

The automated normalization techniques implemented by the data preprocessing and transformation module 418 disclosed herein may foster stability in the optimization process, promoting faster convergence during gradient-based training, thereby mitigating issues related to vanishing or exploding gradients, allowing models to reach optimal solutions more efficiently. The automated normalization techniques implemented by the data preprocessing and transformation module 418 disclosed herein may be a data preprocessing technique used to transform the values of numeric columns in the dataset, i.e., the raw data received from the raw zone 412(1) to a common scale, without distorting differences in the ranges of values or losing information. It's about adjusting the scale of your data to level the playing field for all the features in your dataset.

As mentioned earlier, the automated normalization techniques implemented by the data preprocessing and transformation module 418 disclosed herein may include min-max normalization and z-score normalization (standardization). Min-max normalization scales the data between a specified range (usually 0 and 1), while z-score normalization scales the data so that it has a mean of 0 and a standard deviation of 1.

The formula for calculating the Min-Max Scaling may include the following:

x′=(x−min(x)/(max(x)−min(x),

where x is the original feature value, min(x) is the minimum value in the raw dataset for that feature, max(x) is the maximum value in the dataset for that feature, x′ is the normalized value. This transformation ensures that the minimum value of the data maps to 0 and the maximum maps to 1. When applied to the raw dataset, it brings all the features to a common scale, greatly simplifying the learning process for many machine learning algorithms.

In some embodiments, Z-Score Normalization (Standardization) techniques implemented by the data preprocessing and transformation module 418 disclosed herein transforms the features so they have the properties of a standard normal distribution with a mean of 0 and a standard deviation of 1:

Z=(X−μ)/σ,

where μ is the mean of the feature and σ is the standard deviation.

The importance of normalization becomes apparent in various scenarios, such as improving model accuracy of the configurable test model 405 and the machine learning model 407. Many machine learning algorithms, like gradient descent, converge faster with normalized data. Without normalization, features with higher magnitude may dominate the learning process, leading to less accurate models. Moreover, normalized data may help ensure that each feature contributes equally to the model training process, making it easier for the model to learn the patterns.

In some embodiments, the automated normalization techniques implemented by the data preprocessing and transformation module 418 disclosed herein may enhance compatibility. For example, some algorithms, especially those involving distance calculations like k-nearest neighbors (KNN) and k-means clustering, require normalized data to function correctly because they are sensitive to the magnitude of the data.

At step S508, the de-duplicating data from the raw data may further include removing duplicate records considering the mandatory fields and timestamp fields.

Like all software and data applications, ETL (Extract, Transform, Load)/ELT (Extract, Load, Transform) systems may be prone to failure from time-to-time. So, data quality testing may prove to be the process of validating that key characteristics of a dataset match what's expected prior to consumption by downstream users, i.e., the configurable test model 405 and the machine learning model 407. Among other factors, data pipelines may be reliable if: the data is current, accurate, and complete; the data is unique and free from duplicates; the model is sound and represents reality; and the transformed data is free from anomalies.

In some embodiments, at step S510, the process 500 implemented by the ADEM 406 may include validating, by calling the validating module 420 via the fourth API, the required standard readable format in real time by applying a validation schema algorithms. Validation schema algorithms implemented by the ADEM 406 may include a process of validating that the format, structure and type of received raw data aligns with a set of rules. Schema validation may involve two key components: the schema itself and the data to be validated. The schema acts as a blueprint, outlining the expected format, structure, and data type.

In some embodiments, upon validation, at step S512, the process 500 implemented by the ADEM 406 may include generating, by calling the generating module 422 via the fifth API, a first enriched dataset. The first enriched dataset may be stored onto the enriched zone A 412(2). In some embodiments, the configurable test model 405 may be trained, by calling the training module 424 via the sixth API, by utilizing the first enriched dataset received from the enriched zone A 412(2). Subsequently repeating the step S508 of the data preprocessing and transformation algorithm periodically to generate updated first enriched dataset by calling the data preprocessing and transformation module 418 via the third API. Determining, by calling the determining module 426 via the seventh API, that there is a data drift between the updated first enriched dataset and this first enriched dataset; and retraining the configurable test model 405 again to output a second enriched dataset that takes into account the data drift. The second enriched dataset may be stored onto the enriched zone B 412(3). At step S512, the process 500 implemented by the ADEM 406 may further include creating, by calling the creating module 428 via the eighth API, an alert and executing an automation process to take corrective action in case of model drift due to differences in the updated first enriched dataset and this first enriched dataset.

In some embodiments, at step S514, the process 500 implemented by the ADEM 406 may include training, by calling the training module 424 via the sixth API, the machine learning model 407 with the second enriched dataset received from the zone B 412(3) to improve performance of the machine learning model 407.

In some embodiments, the data source 403(1) may provide employee workforce data; the data source 403(2) may provide employee telephony usage CDR (Call Detail Records)/QSS (Quality of Service Subscription) (i.e., ZOOM®) data, the QSS API enabling enterprise organizations to quickly identify, troubleshoot, and resolve network and service disruptions in near real time for every user, host, and participant across ZOOM® Meetings, Webinars, and Phone; the data source 403(3) may provide workspace data; the data source 403(4) may provide data corresponding to a cloud computing platform; the data source 403(5) may provide data corresponding to a data center, etc., but the disclosure is not limited thereto. Thus, the various data types may include: day/daypart (time), line of business (LOB), region, building, workstation capacity, workstation device, employee segment, datacenter; ZOOM® device, ZOOM® audio and video call performance metrics of employees (i.e., users), ZOOM® proprietary “quality score”, etc., but the disclosure is not limited thereto. The ADEM 406 may be configured to obtain the required fields from a metadata catalog that stores all metadata for each data points corresponding to the data sources 403(1)-403(n).

In an exemplary use case of ZOOM® meeting, but the disclosure is not limited thereto, the ADEM 406 may be configured to implement the process 500 disclosed above to develop and implement a solution that increases the employee ZOOM® experience and reduces the volume of tickets corresponding to technical issues with ZOOM®. For example, the ADEM 406 may be configured to develop a model (i.e., the machine learning model 407 as discussed above) that segments and classifies poor employee ZOOM® meetings based on key data attributes such as ZOOM® audio and video quality, CPU usage data, and network stability in addition to workforce employee segment, workspace configuration, data center compute performance, and day/daypart data. subsequently, information technology operations may be equipped with insight for intervention and management of issues arising from poor ZOOM® meetings with may reduce employee time dropping/reentering calls, and reduce volume of ZOOM® related tickets.

In some embodiments, modeling solution implemented by the ADEM 406 may include a two-part cluster and binary classification model that classifies employees with low quality meetings. The first model may cluster all employee ZOOM® meetings using K-means algorithm discussed earlier to identify the cluster of employee meetings with low quality meeting metrics. The unsupervised cluster output may be utilized as the dependent variable for the second model, i.e., a supervised binary classification model (e.g., XGBoost), but the disclosure is not limited thereto, that may predict the propensity an employee ZOOM® meeting would be a part of the cluster of low-quality meeting type. In some embodiments, the added output and value of model may be: “feature importance” list that may identify top drivers of why employee's submitted ZOOM® tickets corresponding to technical issues for immediate opportunity identification; and a “SHAP” plot that may identify to drivers of why employee's submitted ZOOM® tickets corresponding to technical issues for immediate opportunity identification (at employee meeting level).

Table 1 below illustrates that the unsupervised cluster model creates target/dependent variable for the classification model. Clusters may be collapsed to only “Cluster 1” and “Cluster 0”. “Cluster 1”=poor ZOOM® quality meeting (validated by average number of “drop out and reenter”, and average number of ZOOM® tickets. “Cluster 2”=other (all other clusters combined together. These clusters have good ZOOM® quality metrics).

TABLE 1

| Meeting | Cluster |
|---|---|
| ID | (1, 2, 3, . . . ) |
| 1234 | 1 |
| 2379 | 1 |
| 1834 | 3 |
| 2416 | 2 |
| 3616 | 3 |
| 3916 | 3 |
| 4216 | 1 |
| 4516 | 2 |
| 4816 | 1 |
| 5116 | 2 |

Dependent Variable

| Meeting | Cluster? |
|---|---|
| ID | (1 or other) |
| 1234 | 1 |
| 2379 | 1 |
| 1834 | 0 |
| 2416 | 0 |
| 3616 | 0 |
| 3916 | 0 |
| 4216 | 1 |
| 4516 | 0 |
| 4816 | 1 |
| 5116 | 0 |

In some embodiments, the supervised classification model may run in production every day identify cluster segment of meetings that had issues. The dependent variable of Table 1 may be utilized as input by the supervised classification model to output results corresponding to cluster 1 propensity that may be represented in Table 2 below.

TABLE 2

| Average | | |
|---|---|---|
| CPU | | Cluster 1 |
| Usage | Region | Propensity |
| 95 | 2 | 0.65 |
| 98 | 5 | 0.61 |
| 92 | 1 | 0.57 |
| 97 | 9 | 0.53 |
| Average | | |
| CPU | | Cluster? |
| Usage | Region | (1 or Other) |
| 95 | 2 | 1 |
| 98 | 5 | 1 |
| 92 | 1 | 1 |
| 97 | 9 | 1 |
| | Average | |
| User | CPU | |
| Segment | Usage | Device |
| 4 | 95 | Windows VDI |
| 2 | 98 | Android |

As illustrated in Table 2 above, the supervised classification model may bucket row predication score as “1” or “0” based on a configurable threshold. For example, in an upfront analysis on how many days from ZOOM® meeting to ZOOM® ticket, the model may conduct response rate analysis to identify how days until approximately 80 percent, but the disclosure is not limited there, of positive events occur. The model may run in “batch” every day pulling data from the data sources 403(1)-403(n) discussed earlier for the day before. The output column with score may be a prediction of likelihood that a meeting for the day before was a “cluster 1” meeting, or a poor ZOOM® quality meeting. Raw output may be aggregated and provided by user (employee) segment as discussed earlier. A product team may utilize this raw output in troubleshooting and issue management.

In some embodiments, data attribute for workspace may include the following: Security Identifier (SID), UserSegment, UserSubSegment, EmployeeType, CorporateTitle, JobCode, JobFamily, JobFunction, LOB2, LOB3, LOB4, LOB5, Region, City, State, Country, Building, CommonBldgName, LocationFloor, etc., but the disclosure is not limited thereto. In some embodiments, the SID may include a unique, immutable identifier of a user account, user group, or other security principal corresponding to an operating system running within the ADED 402 as illustrated in FIG. 4.

In some embodiments, employee telephony usage CDR may be obtained through an API in JSON format, but the disclosure is not limited thereto. Need to follow the steps of data retrieval with validation and data transformation as discusser earlier with reference to FIGS. 4-5 for obtaining data in a proper readable format.

The schema validation discussed above may include standardized fields and data types. The ADEM 406 may check whether fields required for further processing are available or not with the defined datatypes. In some embodiments, the defined datatypes corresponding to ZOOM® CDR data discussed earlier may include the following: host, source, sourcetype, UserData.Email, UserData.SID, audio_quality, cribl_hec, cribl_host, cribl_input, cribl_output, cribl_pipe, cribl_route, custom_keys, dept, duration, email, end_time, has_3rd_party_audio, has_archiving, has_automated_captions, has_manual_captions, has_pstn, has_recording, has_screen_share, has_sip, has_video, has_voip, id, in_room participants, index, linecount, metric_type, org_cribl_host, participants, organization, SID, audio_quality, bo_mtg_id, camera, connection_type, customer_key, data_center, device, domain, email, from_sip_uri, full_data_center, harddisk_id, ip_address, join_time, leave_reason, leave_time, location, mac_addr, meeting_UUID, microphone, network_type, participant_user_id, pc_name, recording, registrant_id, role, screen_share_quality, share_application, share_desktop, share_whiteboard, sip_uri, speaker, status, user_id, user_name, version, video_quality, screen_share_quality, splunk_server, start_time, topic, tracking_Fields, unix_category, unix group, user_type, uuid, video_quality, etc., but the disclosure is not limited thereto. Retrieval of raw data may need to extract latest data for processing.

Initially extracted raw data may be persisted in the raw zone 312(1) as discussed earlier with reference to FIGS. 4-5. Partitioning raw data may be performed on a daily basis. In some embodiments, the automated normalization techniques implemented by the data preprocessing and transformation module 418 disclosed above may include interpolation of the raw data, i.e., role may be host, attendees if other records are coming then it may be unknown. Standard Date/Time formats may include conversion of the date type—start_time and end_time in unix timestamp. Unit conversions may include converting video_quality, screen_share_quality, audio_quality in range value. Encoding standards may include UTF-8 for text data.

In some embodiments, it may be necessary to join the CDR dataset mentioned above with workforce data for downstream processing as well as to map it with other dataset—cloud computing platform, workspace, data center, etc. Joining step may include joining the raw data on hashed SID and filter the region specific data to mat it with other data sets. For example, ZOOM® CDR may be enhanced by joining ZOOM® CDR and workforce dataset using SID column. Then joining the enhanced ZOOM® CDR dataset with workspace or hostname or SID column; joining the enhanced ZOOM® CDR dataset with the cloud computing platform on SID and date column; and joining the enhanced ZOOM® CDR dataset with datacenter on host_id column, but the disclosure is not limited thereto.

In some embodiments, the ADED 402 may include a memory (e.g., a memory 106 as illustrated in FIG. 1) which may be a non-transitory computer readable medium that may be configured to store instructions for implementing a platform, language, database, and cloud agnostic ADEM 406 for automated data enrichment to train a machine learning model as disclosed herein. The ADED 402 may also include a medium reader (e.g., a medium reader 112 as illustrated in FIG. 1) which may be configured to read any one or more sets of instructions, e.g., software, from any of the memories described herein. The instructions, when executed by a processor embedded within the ADEM 406 or within the ADED 402, may be used to perform one or more of the processes as described herein. In a particular embodiment, the instructions may reside completely, or at least partially, within the memory 106, the medium reader 112, and/or the processor 104 (see FIG. 1) during execution by the ADED 402.

In some embodiments, the instructions, when executed, may cause a processor embedded within the ADEM 406 or the ADED 402 to perform the following: establishing a communication link among a plurality of data sources and the machine learning model via a communication interface; extracting raw data from each of said plurality of data sources via corresponding application programming interface (API) call, the raw data having diverse data formats; implementing a hashing algorithm on to the raw data received from said plurality of data sources to mask personally identifiable information from the raw data and completing extraction of the raw data with only mandatory fields; applying, after completing extraction of the raw data, a data preprocessing and transformation algorithm on to the raw data by iteratively transforming, aggregating, and de-duplicating data from the raw data to create refined features thereby transforming the raw data into a required standard readable format; validating the required standard readable format in real time by applying a validation schema algorithm; generating, upon validating, a first enriched dataset; and training the machine learning model with the first enriched dataset to improve performance of the machine learning model. In some embodiments, the processor may be the same or similar to the processor 104 as illustrated in FIG. 1 or the processor embedded within the ADED 202, ADED 302, ADED 402, and ADEM 406 which may be the same or similar to the processor 104.

In some embodiments according to the non-transitory computer readable medium, the instructions, when executed, may cause the processor 104 to perform the following: repeating the data preprocessing and transformation algorithm periodically to generate a second enriched dataset; determining that there is a data drift between the first enriched dataset and the second enriched dataset; and retraining the machine learning model with the second enriched dataset to improve performance of the machine learning model.

In some embodiments according to the non-transitory computer readable medium, the instructions, when executed, may cause the processor 104 to perform the following: creating an alert and executing an automation process to take corrective action in case of model drift due to differences in the first enriched dataset and the second enriched dataset.

In some embodiments according to the non-transitory computer readable medium, in applying the data preprocessing and transformation algorithm, the instructions, when executed, may cause the processor 104 to perform the following: transforming values of numeric columns in a dataset of the raw data to a common scale, without distorting differences in ranges of values or losing information.

In some embodiments according to the non-transitory computer readable medium, the instructions, when executed, may cause the processor 104 to perform the following: determining that in the numeric columns there are some missing values; and filling the missing values in the numeric columns with “not applicable” or “null” as per data conversion requirement or replacing the missing values with estimated or calculated values using a regression algorithm.

In some embodiments according to the non-transitory computer readable medium, the instructions, when executed, may cause the processor 104 to perform the following: implementing a minimum-maximum normalization technique and a z-score normalization technique, wherein the minimum-maximum normalization technique scales the raw data between a specified range 0 and 1, and wherein the z-score normalization technique scales the raw data so that it has a mean of 0 and a standard deviation of 1.

In some embodiments according to the non-transitory computer readable medium, the de-duplicating data from the raw data may further include removing duplicate records considering the mandatory fields and timestamp fields.

In some embodiments as disclosed above in FIGS. 1-5, technical improvements effected by the instant disclosure may include a platform for implementing a platform, language, model, database, and cloud agnostic automated data enrichment module configured to automate data standardization and normalization process to train a machine learning model to improve performance of the machine learning model, but the disclosure is not limited thereto. For example, in some embodiments as disclosed above in FIGS. 1-5, technical improvements effected by the instant disclosure may include a platform for implementing a platform, language, model, database, and cloud agnostic automated data enrichment module configured to transform raw data into a standardized, readable format, thereby enhancing data accuracy and accessibility, streamlining data processes, reducing manual effort, and improving decision-making capabilities, and ensuring data integrity and reliability for users, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it may not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automated data enrichment to train a machine learning model by utilizing one or more processors along with allocated memory, the method comprising:
establishing a communication link among a plurality of data sources and the machine learning model via a communication interface;
extracting raw data from each of said plurality of data sources via corresponding application programming interface (API) call, the raw data having diverse data formats;
implementing a hashing algorithm on to the raw data received from said plurality of data sources to mask personally identifiable information from the raw data and completing extraction of the raw data with only mandatory fields;
applying, after completing extraction of the raw data, a data preprocessing and transformation algorithm on to the raw data by iteratively transforming, aggregating, and de-duplicating data from the raw data to create refined features thereby transforming the raw data into a required standard readable format;
validating the required standard readable format in real time by applying a validation schema algorithm;
generating, upon validating, a first enriched dataset; and
training the machine learning model with the first enriched dataset to improve performance of the machine learning model.

2. The method of claim 1, further comprising:
repeating the data preprocessing and transformation algorithm periodically to generate a second enriched dataset;
determining that there is a data drift between the first enriched dataset and the second enriched dataset; and
retraining the machine learning model with the second enriched dataset to improve performance of the machine learning model.

3. The method of claim 2, further comprising:
creating an alert and executing an automation process to take corrective action in case of model drift due to differences in the first enriched dataset and the second enriched dataset.

4. The method of claim 1, wherein in applying the data preprocessing and transformation algorithm, the method further comprising:
transforming values of numeric columns in a dataset of the raw data to a common scale, without distorting differences in ranges of values or losing information.

5. The method of claim 4, further comprising:
determining that in the numeric columns there are some missing values; and
filling the missing values in the numeric columns with “not applicable” or “null” as per data conversion requirement or replacing the missing values with estimated or calculated values using a regression algorithm.

6. The method of claim 4, further comprising:
implementing a minimum-maximum normalization technique and a z-score normalization technique, wherein the minimum-maximum normalization technique scales the raw data between a specified range 0 and 1, and wherein the z-score normalization technique scales the raw data so that it has a mean of 0 and a standard deviation of 1.

7. The method of claim 1, wherein the de-duplicating data from the raw data further comprising:
removing duplicate records considering the mandatory fields and timestamp fields.

8. A system for automated data enrichment to train a machine learning model, the system comprising:
a processor; and
a memory operatively connected to the processor via a communication interface, the memory storing computer readable instructions that, when executed, cause the processor to:
establish a communication link among a plurality of data sources and the machine learning model via a communication interface;
extract raw data from each of said plurality of data sources via corresponding application programming interface (API) call, the raw data having diverse data formats;
implement a hashing algorithm on to the raw data received from said plurality of data sources to mask personally identifiable information from the raw data and completing extraction of the raw data with only mandatory fields;
apply, after completing extraction of the raw data, a data preprocessing and transformation algorithm on to the raw data by iteratively transforming, aggregating, and de-duplicating data from the raw data to create refined features thereby transforming the raw data into a required standard readable format;
validate the required standard readable format in real time by applying a validation schema algorithm;
generate, upon validating, a first enriched dataset; and
train the machine learning model with the first enriched dataset to improve performance of the machine learning model.

9. The system of claim 8, wherein the processor is further configured to:
repeat the data preprocessing and transformation algorithm periodically to generate a second enriched dataset;
determine that there is a data drift between the first enriched dataset and the second enriched dataset; and
retrain the machine learning model with the second enriched dataset to improve performance of the machine learning model.

10. The system of claim 9, wherein the processor is further configured to:
create an alert and executing an automation process to take corrective action in case of model drift due to differences in the first enriched dataset and the second enriched dataset.

11. The system of claim 8, wherein in applying the data preprocessing and transformation algorithm, the processor is further configured to:
transform values of numeric columns in a dataset of the raw data to a common scale, without distorting differences in ranges of values or losing information.

12. The system of claim 11, wherein the processor is further configured to:
determine that in the numeric columns there are some missing values; and
fill the missing values in the numeric columns with “not applicable” or “null” as per data conversion requirement or replacing the missing values with estimated or calculated values using a regression algorithm.

13. The system of claim 11, wherein the processor is further configured to:
implement a minimum-maximum normalization technique and a z-score normalization technique, wherein the minimum-maximum normalization technique scales the raw data between a specified range 0 and 1, and wherein the z-score normalization technique scales the raw data so that it has a mean of 0 and a standard deviation of 1.

14. The system of claim 8, wherein the de-duplicating data from the raw data wherein the processor is further configured to:
removing duplicate records considering the mandatory fields and timestamp fields.

15. A non-transitory computer readable medium configured to store instructions for automated data enrichment to train a machine learning model, the instructions, when executed, cause a processor to perform the following:
establishing a communication link among a plurality of data sources and the machine learning model via a communication interface;
extracting raw data from each of said plurality of data sources via corresponding application programming interface (API) call, the raw data having diverse data formats;
implementing a hashing algorithm on to the raw data received from said plurality of data sources to mask personally identifiable information from the raw data and completing extraction of the raw data with only mandatory fields;
applying, after completing extraction of the raw data, a data preprocessing and transformation algorithm on to the raw data by iteratively transforming, aggregating, and de-duplicating data from the raw data to create refined features thereby transforming the raw data into a required standard readable format;
validating the required standard readable format in real time by applying a validation schema algorithm;
generating, upon validating, a first enriched dataset; and
training the machine learning model with the first enriched dataset to improve performance of the machine learning model.

16. The non-transitory computer readable medium of claim 15, wherein the instructions, when executed, cause the processor to further perform the following:
repeating the data preprocessing and transformation algorithm periodically to generate a second enriched dataset;
determining that there is a data drift between the first enriched dataset and the second enriched dataset; and
retraining the machine learning model with the second enriched dataset to improve performance of the machine learning model.

17. The non-transitory computer readable medium of claim 16, wherein the instructions, when executed, cause the processor to further perform the following:
creating an alert and executing an automation process to take corrective action in case of model drift due to differences in the first enriched dataset and the second enriched dataset.

18. The non-transitory computer readable medium of claim 15, wherein in applying the data preprocessing and transformation algorithm, the instructions, when executed, cause the processor to further perform the following:
transforming values of numeric columns in a dataset of the raw data to a common scale, without distorting differences in ranges of values or losing information.

19. The non-transitory computer readable medium of claim 18, wherein the instructions, when executed, cause the processor to further perform the following:
determining that in the numeric columns there are some missing values; and
filling the missing values in the numeric columns with “not applicable” or “null” as per data conversion requirement or replacing the missing values with estimated or calculated values using a regression algorithm.

20. The non-transitory computer readable medium of claim 18, wherein the instructions, when executed, cause the processor to further perform the following:
implementing a minimum-maximum normalization technique and a z-score normalization technique, wherein the minimum-maximum normalization technique scales the raw data between a specified range 0 and 1, and wherein the z-score normalization technique scales the raw data so that it has a mean of 0 and a standard deviation of 1.
